(19) United States
(12) Patent Application Publication
(10) Pub. No.: US 2004/0031022 A1
(43) Pub. Date: Feb. 12, 2004

(54) Information processing device for multiple instruction sets with reconfigurable mechanism

(76) Inventors: Masayuki Kabasawa, Kokubunji (JP); Naohiko Irie, Kokubunji (JP); Takanobu Tsunoda, Kokubunji (JP); Takahiro Irita, Higashimurayama (JP); Keisuke Toyama, Yokohama (JP); Tetsuya Yamada, Kodaira (JP)

Correspondence Address: REED SMITH LLP, Suite 1400, 3110 Fairview Park Drive, Falls Church, VA, 22042, US

(21) Appl. No.: 10/608,015

(22) Filed: Jun. 30, 2003

(30) Foreign Application Priority Data
Aug. 2, 2002 (JP) P2002-225487

(51) Int. Cl. G06F 9/45

(52) U.S. Cl. 717/139; 718/1

(57) ABSTRACT

Disclosed here is a mechanism provided in an instruction translator for translating an intermediate code (Java bytecode) to an instruction string so as to be interpreted by an instruction execution block corresponding to various upgraded versions of a virtual machine (computer) (VM). Each instruction included in the first instruction group of the intermediate code is translated to an instruction to be interpreted by hardware while each instruction included in the second instruction group is translated by software. The information processing device is configured so that the intermediate code has a storage area for storing information for denoting which of the first and second instruction groups includes the intermediate code. Thus, instruction translation can be made by the same hardware to cope with various upgraded versions of a VM if the values are set in the setting register. In addition, the hardware is not required to be modified to translate instructions even when the VM version is upgraded.

### BACKGROUND OF THE INVENTION

1. Field of the Invention

The present invention relates to an information processing device. More particularly, the present invention relates to the compatibility among versions of an intermediate language employed for an information processing device that executes the intermediate language fast.

2. Description of Related Art

In recent years, the use of the Java language is rapidly spread for describing application programs used in portable telephones and portable terminals. Java is an object-oriented programming language similar to the C++ developed by Sun Microsystems, Inc. “Java” is a trademark of Sun Microsystems Inc. One of the reasons why the Java language is employed widely such way is its features that each program described with the Java language is translated into CPU instructions specific to each machine (specific instructions) with use of a virtual machine distributed in the format of an intermediate language so as to be executed. Any CPU that is provided with such a virtual machine at the time of execution can execute Java application programs regardless of the CPU type, so that the portability of such Java application programs is high. An intermediate language means a result of compiling for generating a Java execution object. It is referred to a Java bytecode or abbreviated just as a bytecode.

A virtual machine (hereinafter, to be referred to as a “VM”) is generally supplied as software (hereinafter, to be referred to as a “soft VM”) . The operation speed of such a virtual machine is generally low, since each bytecode is interpreted by an interpreter provided therein before it is executed. Consequently, a hardware accelerator is often used to execute each frequently used bytecode in hardware, thereby the bytecode execution is speeded up. An example of such a hardware accelerator is described in “Nikkei Electronics” (no. 797, pp. 168-176, Jun. 4, 2001 (this article is translated from “Java to go”; Part 1; Microprocessor Report, vol. 15, no. 2, February 2001)).

In prior to the application of the present invention, the inventor et al have examined conventional problems to arise from VM version upgrading when a hardware accelerator is used to process bytecodes. A hardware accelerator is usually used for a specific version VM to execute some or all of the instructions defined by the VM to speed up the execution. If a VM version is upgraded after a hardware accelerator is manufactured, therefore, the hardware operation is often not assured. To avoid such a trouble, therefore, the hardware itself is upgraded in accordance with the VM version upgrading and this causes the development efficiency of the hardware to be degraded.

The specification of the VM is decided by Sun Microsystems, Inc. Sun Microsystems, Inc. discloses a plurality of VM specifications as Java2. Among the plurality of VM specifications, J2ME is a specification for embedded systems. This J2ME specification is further divided into two; CDC for network information devices and CLCD for portable network information devices. The CLDC limits CPU and memory types. However, the same basic bytecode set is used for both CDC and CLDC.

Besides the basic bytecodes, there are also extended bytecodes included in a specification dependent on the Java VM implementation. Those extended bytecodes are assigned newly to a code space left over after the assignment of the basic bytecodes, so that complicated bytecodes can be replaced with simple extended bytecodes during Java execution. While the extended bytecodes are not defined in any VM specification and their processing contents are decided independently, the reference implementation denoted by Sun Microsystems, Inc. is practically assumed as the standard. Different extended bytecode sets are used for CDC and CLDC. In addition, even in reference implementation minor version upgrading, the extended bytecode processing content changes and operation code assignment changes even between bytecodes used for the same processing. The difference between those VM versions can be eliminated easily by a software interpreter. However, if an attempt is made for supporting extended bytecode execution with hardware, it is required to manufacture new hardware each time the VM version is upgraded. The inventor et al. of the present invention have thus noticed that the hardware development efficiency comes to be degraded under such circumstances. In addition, the structures of fields and arrays in the Java specification often differ among VM versions, so that the efficiency of hardware manufacturing in accordance with each VM version becomes low.

### SUMMARY OF THE INVENTION

It is an object of the present invention to provide an information processing device capable of coping with upgraded VM versions when instructions defined by a VM are executed by hardware.

Hereunder, typical one of the present invention objects disclosed in this specification will be described briefly. Concretely, it is an information processing device configured by an instruction execution block for executing a first instruction set as a specific instruction and an instruction translator for translating each instruction included in a first instruction group of a second instruction set to the first instruction set to be supplied to the instruction execution block. The information processing device, when receiving an instruction included in the second instruction group of the second instruction set, which is not translated by the instruction translator, translates the instruction with use of software to the first instruction set so as to be executed by the instruction execution block while the instruction translator includes a first storage area for storing information for denoting which of the first or second instruction group of the second instruction set includes the received instruction so as to be redefined.

Furthermore, the instruction translator should preferably include a controller for storing each operation code defined by the first version of the software and controlling its processing, as well as a second storage area added to the first storage area or substituted for the first storage area. The second storage area is used for updating the relationship between each operation code stored in the controller and its processing when the software version is upgraded.

Furthermore, the instruction translator should preferably be provided with a third storage area added to the first storage area or substituted for the first storage area: The third storage area is used to store information for disposing arrays and fields defined in the second instruction set in a memory so as to be redefined.

### BRIEF DESCRIPTION OF THE DRAWINGS

FIG. 1 is a schematic block diagram of an information processing device of the present invention;

FIG. 2 is a block diagram of an execution bytecode specification register;

FIG. 3 is an example for setting an execution bytecode specification register;

FIG. 4 is a block diagram of an extended bytecode map register;

FIG. 5 is an example for assigning extended bytecodes to cope with different VM versions;

FIG. 6 is a block diagram of an array/field offset register;

FIG. 7 is a structure of an array/field;

FIG. 8 is a schematic block diagram of an accelerator of the present invention; and

FIG. 9 is a schematic block diagram of a portable information system of the present invention.

### DETAILED DESCRIPTION OF THE PREFERRED EMBODIMENTS

Hereunder, a preferred embodiment of the present invention that is an information processing device/system will be described with reference to the accompanying drawings. Although not limited specially, the information processing device is to be formed on one semiconductor substrate made of, for example, single crystal silicon with use of a technique for such semiconductor integrated circuits as well-known CMOSs (complementary MOS transistors), bipolar transistors, etc.

(1) System Configuration

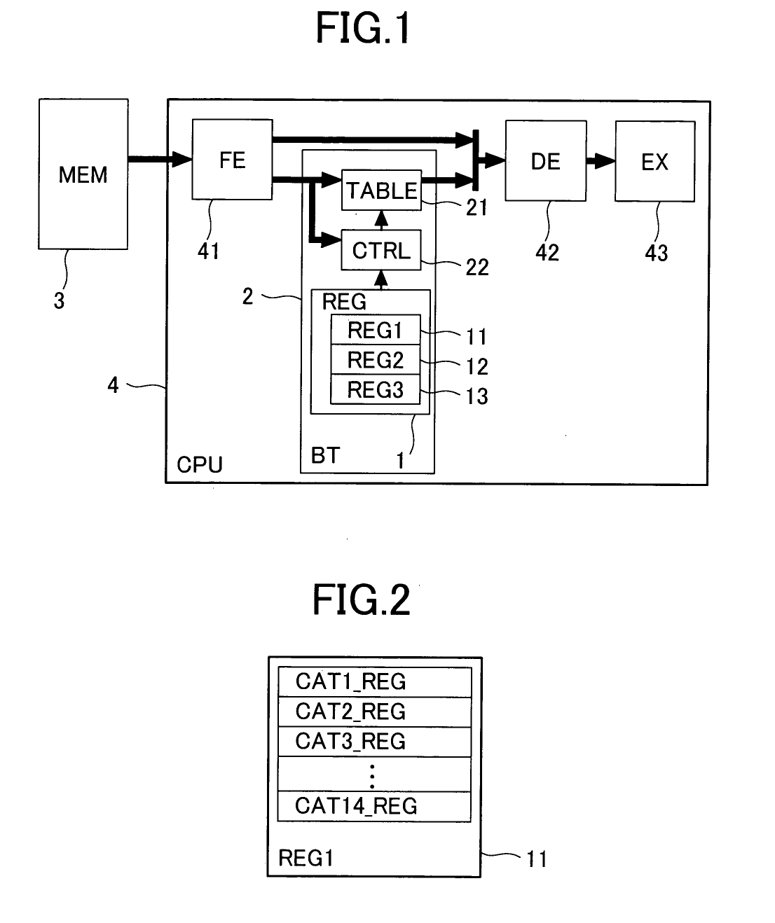

FIG. 1 shows a block diagram of an information processing system in an embodiment of the present invention. Similarly to general processors, a processor chip CPU 4 in FIG. 1 has an instruction set specific to this processor (specific instructions), which differs from the Java bytecode. Although not limited specially, the CPU 4 in this embodiment includes a fetching block (fetch circuit) 41, an instruction translation block (instruction translator) 2, a decoding block (instruction decoder) 42, an instruction execution block (instruction execution circuit) 43 that are all formed on one semiconductor substrate. A memory unit 3 retains information required to execute such Java items as the Java bytecode, the soft VM, the frame, etc. In addition, the memory unit 3 also includes a work area, etc. used to execute application and other software programs described with specific instructions. The memory unit 3 is expected to include such an SRAM as a cache memory, a DRAM to be used as a main memory, or another item used as both of the cache memory and the main memory. Each of the SRAM, the DRAM, etc. may be formed on the same chip as that of the CPU 4 or separately on different chips.

If an ordinary instruction specific to the CPU 4 is supplied from the memory unit 3, the instruction is executed in a path (41−>42−>43) that does not pass through the instruction translation block 2. On the other hand, if a bytecode is supplied from the memory unit 3, the bytecode passes through the fetching block 41 and it is inputted to the instruction translation block 2. The inputted bytecode is then translated to a specific instruction string and transferred to the decoding block 42 and executed in the execution block 43.

If a supported bytecode (the first instruction group) to be subjected to instruction translation in the translator 2 is inputted to the CPU 4, it is translated to a specific instruction or specific instruction string in the bytecode translation table 21 in accordance with the Java bytecode. If an unsupported bytecode (the second instruction group) is inputted and it is not. subjected to instruction translation in the translator 2, but subjected to instruction translation in the soft VM, the controller 22 detects it and outputs an instruction string for switching the bytecode translation table 21 over to the soft VM. This instruction string is thus executed to pass control to the soft VM.

As described above, the present invention selects the instruction translator or soft VM for executing each processing according to a check result of whether the bytecode is supported or unsupported. In this connection, the instruction translator, which is a hardware item, is designed for a specific VM version. If the VM version is upgraded, however, each bytecode compiled in the upgraded VM version to cope with definition changes might not function as required in the instruction translator formed in accordance with the old VM version. To avoid such a trouble, the inventor et al of the present invention has examined the contents of the upgraded VM versions and found that a setting register 1 that can store parameters so as to be redefined (to be described in detail later) is effective to cope with VM version upgrading in the past and future.

Concretely, values in the setting register 1 are reset to correspond to each VM version upgrading flexibly. Typically, if an instruction translator is formed for VM version 1, the soft VM corresponding to the VM version 1 and the first parameter table of the setting register 1 are stored in the memory unit 3. In this connection, when the CPU 2 is powered and initialized, the first parameter is loaded into the setting register from the memory unit 3 so as to initialize the instruction translator. The instruction translator is thus paired with the version 1 soft VM for operations. The first parameter initial value may be set as a default value in the setting register 1 unless otherwise specified specially.

If the VM version is upgraded to version 2, the version 2 soft VM and the second parameter table paired with the version 2 soft VM are stored in the memory unit 3. In this case, the instruction translator can be paired with the version 2 VM for enabling operations even in the VM of version 2.

Furthermore, the present invention also enables a pair of each version soft VM and a parameter table to be switched even when there are two bytecode application programs compiled by both of versions 1 and 2.

In this connection, the setting register 1 should include at least an execution bytecode specification register (the first storage area) 11, and more preferably include an extended bytecode specification register (the second storage area) 12, and still more preferably include an array/field offset register (the third storage area) 13. Hereinafter, the function of each of those registers 11 to 13 will be described in detail.

(2) How to Specify a Supported Bytecode

The bytecode specification register 11 specifies each bytecode to be executed by hardware. There are two methods for using such a register 11; one method prepares a register for all operations code for each bytecode and the other method prepares a register for each instruction category. In this embodiment, although not limited specially, the latter method that requires a smaller register size is employed.

FIG. 2 shows a detailed configuration of the execution bytecode specification register 11. In the present invention, although not limited specially, about 230 bytecodes are classified into such 14 categories as a local variable access instruction group, an array access instruction group, a 32-bit operation instruction group, a 64-bit operation instruction group, a floating decimal point instruction group, a stack handling instruction group, a subroutine jump/return instruction group, a flow control instruction group, etc. And, one or more bytecodes are included in each of those instruction categories. The category 1 execution specification register CAT1_REG is a single bit register for specifying “0 ” or “1 ” for whether the first category bytecode is to be handled as a supported instruction or unsupported instruction. Other registers CAT2_REG to CAT14_REG are also used for other categories similarly.

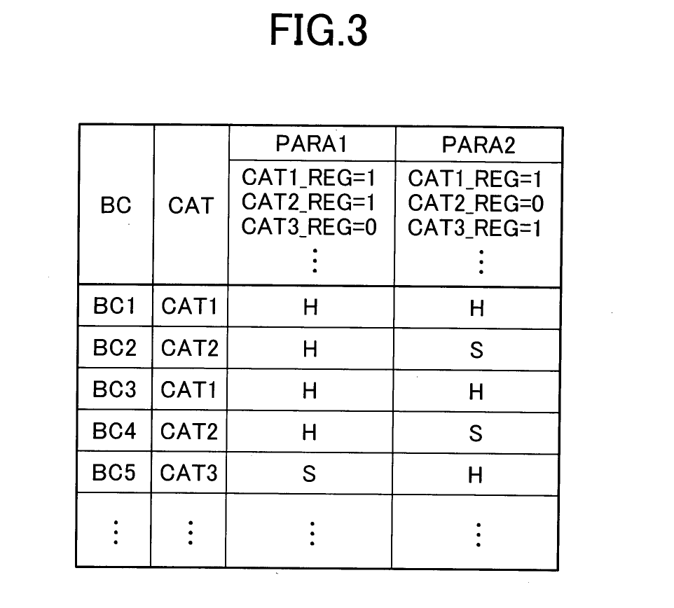

FIG. 3 shows a table for denoting whether each bytecode is executed by hardware or soft VM. BC1, BC2, . . . that are bytecodes BC are classified into categories 1CAT1, 2CAT2, . . . In this connection, if the first parameter table PARA1 is set in the execution bytecode specification register 11 (CAT1_REG=1, CAT2_REG=2, CAT3_REG=0), BC5 is executed by the soft VM as denoted by a symbol “S” within the range shown in FIG. 3. On the other hand, BC1 to BC4 are set so as to be executed by hardware as denoted by a symbol “H”.

If the second parameter table PARA2 is set in the execution bytecode specification register 11 (CAT1_REG=1, CAT2_REG=0, CAT3_REG=1, . . . ), BC2 and BC4 are executed by soft VM while BC1, BC3, and BC5 are executed by hardware within the range shown in FIG. 3.

[22]

Another typical example for setting bytecodes in the execution bytecode specification register 11 will become as follows. If a VM version is upgraded after the subject processor is mounted in a system, thereby, for example, an array structure is changed, then the category execution specification bit of the category that includes a bytecode related to the array access is set so as to be handled as an unsupported instruction. Consequently, the controller 22 detects the array access bytecode as an unsupported bytecode and the bytecode translation table 21 issues an instruction string for switching the hardware over to the soft VM, thereby control is passed to the soft VM. The bytecode is thus executed by the soft VM. If an array structure comes to differ after the upgrading of a VM version as described above, the category execution specification bit is set so that instructions are handled as unsupported ones, thereby the system can correspond to any VM versions with different array structures. In addition, even when the floating decimal point notation differs among VM versions and when 64-bit operations are disabled in the endian specification, the subject category execution specification bit is set so that instructions are handled as unsupported ones, thereby control is passed to the soft VM.

Although a method for preparing a register for each category is employed in this embodiment, the present invention is not limited only to that embodiment. The Java bytecode includes about 230 operation codes. If a single bit register is allocated for each operation code, the total number of latch registers becomes 230 and the instruction translation comes to increase in scale. If a register is prepared for each category, the circuit scale can be reduced. However, if an instruction set that includes less operation codes is to be handled, no problem arises from the circuit scale even when only one register is prepared for all the operation codes.

(3) How to Specify an Extended Bytecode

FIG. 5 shows how the processing of each extended bytecode and the assignment of operation codes come to differ among VM versions. An extended bytecode means a bytecode for specifying such an extended instruction specific to a VM version as the defined getfield_quick so as to speed up the execution of each basic instruction in addition to such basic instructions as iload and iadd in Java. At first, how bytecode processing content differs among VM versions will be described. In FIG. 5, an extended bytecode EXBC5 is assumed to be assigned to the operation code 234 in the version 1 VM1. On the contrary, an extended bytecode EXBC5 is unsupported, so that it is defined as NON in the version 2 VM2. Next, how assignment of operation code numbers differs among VM versions will be described. For example, the processing of the bytecode EXBC1 is assigned to the operation code No. 230 in the VM1 while it is assigned to the operation code No. 235 in the VM2. This difference between the versions is eliminated by an extended bytecode map register 12.

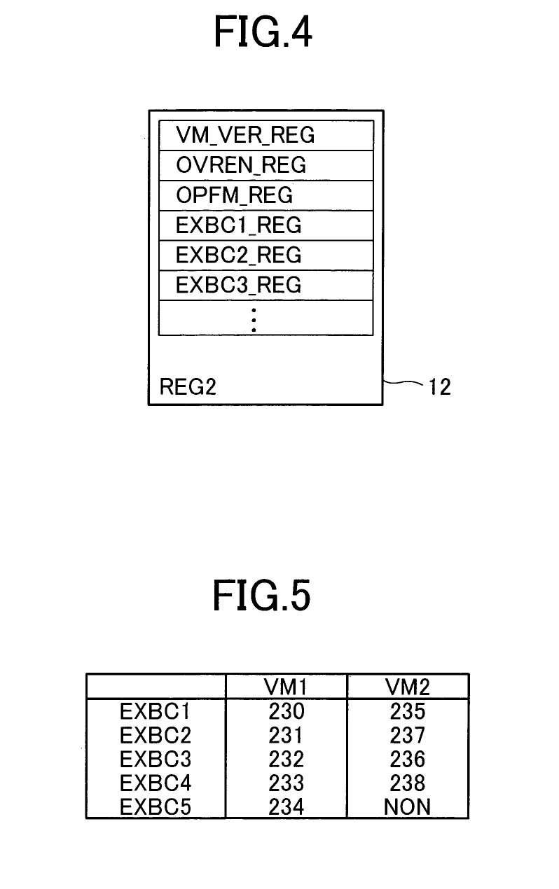

FIG. 4 shows a detailed configuration of an extended bytecode specification register 12. This register 12 includes a specific VM version specification register VM_VER_REG, an operation code overwrite enable specification register OVREN_REG, an operand format specification register OPFM_REG, and extended bytecode specification registers EXBC1_REG, EXBC2_REG, EXBC3_REG, . . .

The specific VM version specification register VM_VER_REG sets “0” to specify, for example, version 1 and “1” to specify version 2 when version 1 and version 2 already exist. If there are more versions, the bit of this VM_VER_REG may be extended in width to specify a desired one. The controller 22 is expected to store operation codes and their processings with respect to both of the versions 1 and 2 defined at the time of manufacturing. Consequently, the specific VM version specification register VM_VER_REG functions as a switch for specifying which of the versions 1 and 2 is to be used for the target processing.

On the other hand, if the VM version is upgraded and an expected extended bytecode operation code is invalidated after the subject processor is mounted in a system, “enable” is set in the operation code overwrite enable specification register OVREN_REG while an operation code matching with the processing of the extended bytecode EXBC1 is set in the extended bytecode specification registers EXBC1_REG. For example, in the example shown in FIG. 5, EXBC1 is 230 in the version 1 while it is 235 in the version 2. And, the specific VM version specification register VM_VER_REG can be used to switch between the versions 1 and 2 as described above. On the other hand, if 240 is assigned for EXBC1 upgraded again in version 3, “1” is set in the OVREN_REG and “240” is set in the EXBC1_REG. Other extended bytecode specification registers EXBC2_REG, EXBC3_REG, . . . are also set similarly. Then, the controller 22 checks if the bytecode inputted to the instruction translator 2 matches with the operation code set in the extended bytecode specification register. If they match, the bytecode translation table 21 outputs the corresponding instruction string. If they do not match, the table 21 outputs an instruction string for passing control to an unsupported processing, thereby control is passed to the soft VM.

The operand format specification register OPFM_REG is used to change the method for specifying the operand format of the extended bytecodes of fields. This is to cope with changes of bytecode operands for accessing fields to be made according to version upgrading. A field extended instruction is specified with 3 bytes consisting of a single-byte operation code and a 2-byte operand that follows the operation code. However, the 2-byte operand might be changed as follows; (1) the first operand is valid/the second operand is valid, (2) the first operand is valid/the second operand is invalid, and (3) the first operand is invalid/the second operand is valid. And, the operand format can be changed like (1) to (3) described above by specifying such values as “00”, “01”, and “10” in the operand format specification register OPFM_REG. The OPFM_REG is required to be set when “enable” is set in the OVREN_REG and it is not required to be set when a default value is used therein.

Although a description has been made for how extended bytecodes cope with VM upgrading, there are also some cases in which the method described above is not effective. In such a case, the execution bytecode specification register 11 is set for unsupported instructions so as to correspond to the soft VM. Consequently, if it is considered important to eliminate a difference between upgraded VM versions, the execution bytecode specification register 11 will be used more practical than the OPFM_REG. The significance of the execution bytecode specification register 11 is also to maintain the hardware performance.

(4) How to Specify an Array/Field Offset

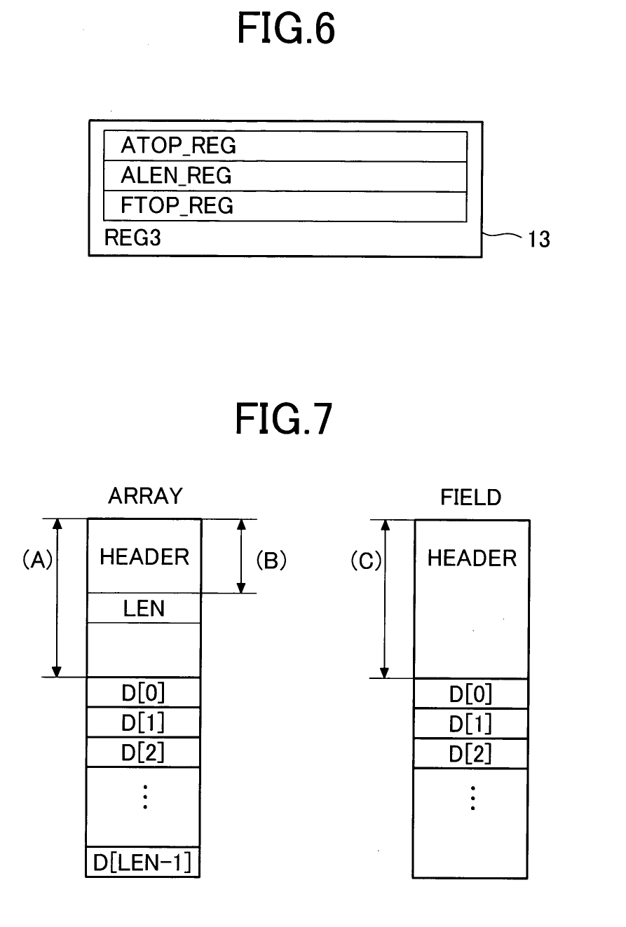

In some cases, the structure of arrays/fields differs among VM versions. The present VM has a header part at the start of each array and an offset of the header part is added to an address to access the data therein. In the future, it is expected that such a header offset might be changed according to VM upgrading. This is why an array start offset register ATOP_REG is prepared in the array/field offset register 13 as shown in FIG. 6 so as to enable the offset to be changed in accordance with such VM upgrading. The array length LEN is set in the header part of each array and an offset that covers up to the array length LEN field is set in the array length field offset register ALEN_REG. When all those settings are completed, the bytecode translation table 21 outputs an instruction string corresponding to those settings. The above description can also apply to fields. The field start offset register FTOP_REG is provided, so that the special instruction table 23 issues instruction strings. FIG. 7 shows a Java's concept chart for arrays and fields. In FIG. 7, (A) denotes set contents of an array offset specification register, (B) denotes set contents of an array length field offset specification register, and (C) denotes set contents of a field offset specification register.

If the method described above cannot correspond to a VM after its version upgrading, the execution bytecode specification register 11 is set for unsupported instructions so as to correspond to the soft VM. Consequently, if it is considered important to eliminate a difference between upgraded VM versions, the execution bytecode specification register 11 will be used more practically than the OPFE_REG. As described above, the significance of the execution bytecode specification register 11 is also to maintain the hardware performance.

This completes the description for how to specify a supported bytecode, how to specify an extended bytecode, and how to specify an array/field offset with respect to each of the corresponding registers 11 to 13. However, the classification of the registers 11 to 13 and the detailed register configuration in each of those registers 11 to 13 are just for reasons of convenience. This embodiment may be modified if a storage area is provided to store information corresponding to each of the registers described in this specification, since the object of the present invention is to be achieved as a natural consequence. Although the registers employed in this embodiment are expected to be volatile latch registers capable of reading/writing data, the registers may be replaced with another type ones if they have a storage area to be redefined respectively.

(5) How to Specify the Stack Top Pointer

In Java, the CPU performs an operation after storing the variables into the stack. When the stack structure is achieved by a general CPU where the number of registers is limited, the data region is assigned in the memory and the general CPU transfers the data back and forth the memory and the register. In this case, the stack structure is realized effectively by stacking the data in the memory and holding the stack top pointer, which is the top address of a plurality of data stacked in the memory. The reason in which the stack structure is adopted in Java is that only one of the general registers is occupied and Java is easily adaptable to the general CPUs with different numbers of general registers. But the structure of the stack top pointer is different by VM versions as shown in FIG. 10. To put it concretely, in version 1 (VM1), an invalid data is stored in the address indicated by the stack top pointer and a valid data is stored in the next address indicated by the stack top pointer. On the other hand, in version 2 (VM2), a valid data is stored in the address indicated by the stack top pointer.

The inventers found out that the CPU performs different operations by different VM versions, even when a same bytecode is inputted because this difference exists. Concretely, when the data is transferred from the general register to the memory or from the memory to the general register, the destination address or the source address of the memory must be changed according to VM versions. To avoid such trouble, the inventers adopted the composition of switching an instruction outputted from the instruction translator BT in accordance with VM versions. Concretely, when the data is transferred from the general register R0 to the memory, in version 1 (VM1) the instruction translator BT outputs MOV R0,@R10 means post-indirectal load and in version 2 (VM2) the instruction translator BT outputs MOV R0,@+R10 means pre-indirectal load. Wherein @R10+ and @+R0 mean the destination address. The sign(+) means the increase of the address of the memory, and the position of the sign(+) means post or pre. As described above, the CPU is adaptable to different structure of stack top pointer according to the VM version by outputting the instruction in accordance with VM versions from the instruction translator BT.

FIG. 10 shows one embodiment of a method of switching the instructions. Only the destination address is different in MOV R0, @R10+ and MOV R0, @+R10 which is corresponding to version 1 (VM1) and version 2 (VM2) , respectively. This difference means that the bits constructing of the instruction is slightly different. Thus the inventor adopted the composition of storing the instruction of either version 1 (VM1) or version 2 (VM2) in the bytecode translation table 21, and by using the converting circuit CONV, converting the different part of the instruction read out from the bytecode translation table 21. The converting circuit CONV converts the instruction by using the specific VM version specification register VM_VER_REG, which stores the VM version information. By adopting this composition, the bytecode translation table 21 becomes smaller compared to storing the instructions according to each of the VM versions into the bytecode translation table 21. In the conversion circuit CONV, whether to convert the instructions or not is controlled by the control signal CONT. The control signal CONT is inputted to the conversion circuit when a data is transferred from the general register to the memory or from the memory to the general register. In FIG. 10, the specific VM version specification register VM_VER_REG is used, but it is also possible to provide a new stack top pointer register. In this case, it is easier to adapt the CPU into system, because the structure of the stack top pointer regardless of the version. It is also possible to store the common part of the instruction of the version 1 and version 2 in the bytecode translator table 21 and add the different part of the instruction according to the information held in the specific VM version specification register VM_VER_REG in conversion circuit CONV.

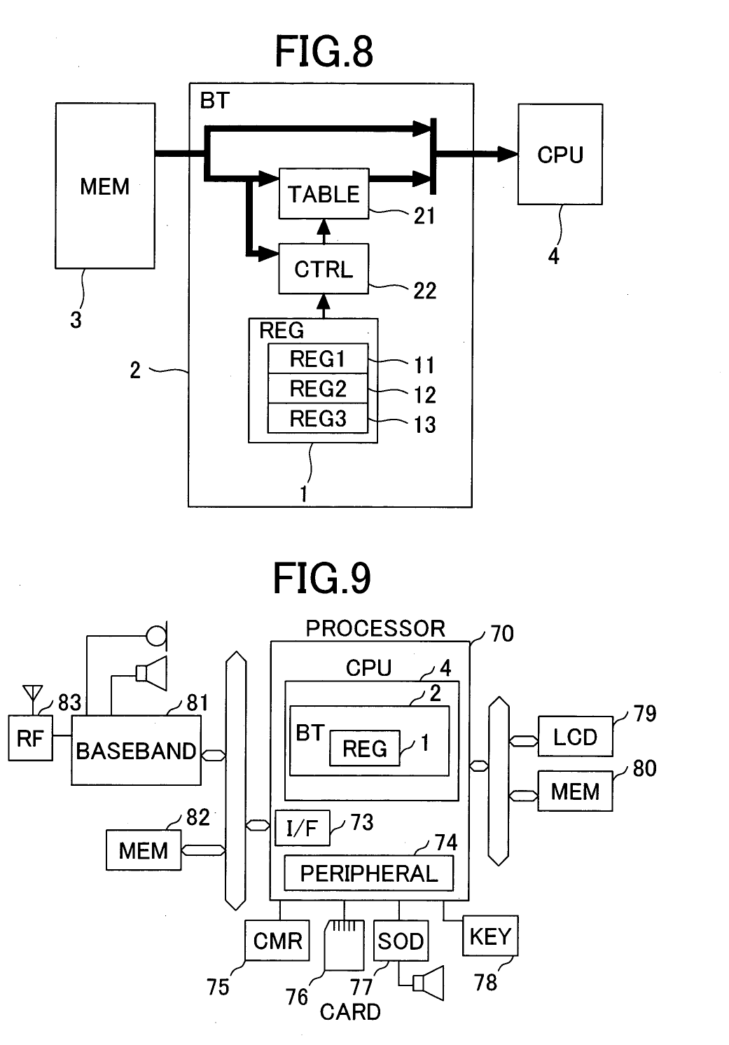

FIG. 8 shows a block diagram of an information processing device in the second embodiment of the present invention. Unlike the first embodiment shown in FIG. 1, an instruction translation block 2 in this second embodiment is provided outside the CPU 4 and this instruction translation block is formed on a semiconductor chip independently of the chip of the CPU 4 that executes specific instructions. Because the instruction translation block 2 is formed on a chip separately from that of the CPU 4 such way, the instruction translation block 2 can apply to an existing CPU chip. This is an advantage of this second embodiment. The setting register 1 is similar to that in the first embodiment and can cope with the difference among VM versions similarly to the first embodiment shown in FIG. 1.

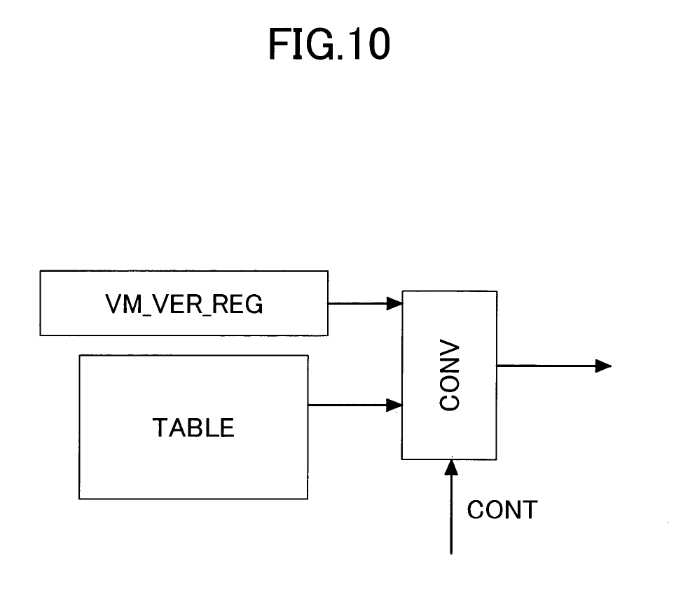

FIG. 9 shows a block diagram of a portable information system as a preferred application example of the present invention. More concretely, the block diagram is for a configuration of a portable telephone. The portable information system is roughly divided into a communication block and an application block. The communication block comprises an antenna (RF) 83 for sending/receiving radio waves, a baseband modem, a baseband processor (BASEBAND 81 for performing CODEC operations, and a main memory (MEM) 82. The application block includes a microprocessor (PROCESSOR) 70 in which a CPU 1 is built. The CPU 1 includes a bytecode accelerator 10 of the present invention. In the microprocessor 70, an application processor and a baseband processor are connected to each other through an interface (I/F) 73 while a camera (CMR) 75, a memory card (CARD) 76, a sound source IC (SOD) 77, and a key (KEY) 78 are connected to each another through a peripheral interface (PERIPHERAL) 74. In addition, a liquid crystal display (LCD) 79 is connected to a main memory (MEM) 80 through an external bus. Although this system configuration is for a portable telephone, it may also apply to such various devices as portable information terminals, digital cameras, etc.

This system configuration includes the following memory, for example. Java application programs are supplied from external servers through the antenna 83 and stored in the main memory 82 through the baseband processor 81. The soft VM may be disposed in any of the main memories 80 and 82. The soft VM interpreter block, which is frequently accessed, should be disposed in the built-in memory. The present invention uses a hardware accelerator so as to execute downloaded Java application programs fast even when those programs are compiled by different versions of the VM. The value added to the portable information system is therefore improved.

While a description has been made for Java as examples so far, the present invention is not limited only to Java; it can also apply to a hardware accelerator used for processors that execute instructions specific to intermediate languages and the VM as instruction sets similarly to Java.

What is claimed is:

1. An information processing device, comprising:
an instruction execution block for executing a first instruction set as a specific instruction; and
an instruction translator for translating an instruction included in a first instruction group of a second instruction set to said first instruction set to be supplied to said instruction execution block,
wherein said information processing device, when receiving an instruction included in a second instruction group of the second instruction set, which is not translated by said instruction translator, translates the instruction included in the second instruction group to the first instruction set with use of software so as to be executed by said instruction execution block, and
wherein said instruction translator has a first storage area for storing an information to be able to redefine whether each of the instruction of the second instruction set is included in the first instruction group or the second instruction group.

2. The information processing device according to claim 1,
wherein the instructions of the second instruction set is classified into a plurality of instruction categories, and
wherein the first storage area stores the information according to each of the plurality of the instruction categories..

3. The information processing device according to claim 2,
wherein each of said plurality of instruction categories includes any one of a local variable access instruction group, an array access instruction group, a 32-bit operation instruction group, a 64-bit operation instruction group, a floating decimal point instruction group, a stack handling instruction group, a subroutine jump/return instruction group, and a flow control instruction group.

4. The information processing device according to claim 1,
wherein said instruction translator, when receiving the instruction of the second instruction set, refers to the information stored in the first storage area to change the inputted instruction to a first instruction format one if it is included in the first instruction group or to let the software to execute the inputted instruction if it is included in the second instruction group.

5. The information processing device according to claim 1,
wherein said software is described with said first instruction set.

6. The information processing device according to claim 1,
wherein said instruction translator includes:
a controller for storing an operation code defined in a first version of the software and controlling its processing and a second storage area for changing a relationship between the operation code stored in said controller and its processing when the software version is upgraded.

7. The information processing device according to claim 6, wherein said instruction translator includes a third storage area for storing information used to dispose an array or field defined in the second instruction set in a memory so as to be redefined.

8. The information processing device according to claim 7,
wherein the third storage area includes:
a first area for storing an offset value for between the start address of said memory and the start entry of an array when said array is defined in the second instruction set and disposed in said memory;
a second area for storing an offset value for between the start address of said memory and a field for storing a length of said array when said array is to be disposed in said memory; and
a third area for storing an offset value for between the start address of said memory and the start entry of said field when a field defined in said second instruction set is disposed in said memory.

9. An information processing device, comprising:
an instruction execution block for executing a first instruction set as a specific instruction; and
an instruction translator for translating an instruction included in a first instruction group of a second instruction set to said first instruction set to be supplied to said instruction execution block,
wherein said information processing device, when receiving an instruction included in a second instruction group of said second instruction set, which is not translated by said instruction translator, translates said received instruction with use of software to said first instruction set so as to be executed by said instruction execution block, and
wherein said instruction translator includes:
a controller for storing an operation code defined by the first version of said software and its processing; and
a second storage area for changing a relationship between said operation code stored in said controller and its processing when the version of the software is upgraded.

10. The information processing device according to claim 9,
wherein said controller also stores an operation code defined in the second version of the software and its processing in addition to the relationship between the operation code defined by the first version of the software program and its processing, and
wherein said second storage area includes an area for specifying a relationship between said controller and the first or second version so as to be redefined.

11. The information processing device according to claim 9,
wherein said controller stores a relationship between an operation code defined in the first version of the software and its processing, wherein said second storage area includes:
a first area for specifying that part of the relationship between an operation code stored in said controller and its processing is invalidated so as to be redefined; and
a second area for storing a new operation code for the processing invalidated by said first area so as to be redefined.

12. The information processing device according to 5 claim 9,
wherein said second instruction set is the Java bytecode,
wherein said software is a software virtual machine that executes said Java bytecode in said information processing device, and
wherein said second storage area can reset a relationship between an operation code of an extended bytecode of said Java bytecode and its processing content.

13. An information processing device, comprising:
an instruction execution block for executing a specific instruction; and
an instruction translator for translating an instruction included in a first instruction group of the Java bytecode to said specific instruction to be supplied to said instruction execution block,
wherein said information processing device, when receiving an instruction included in a second instruction group of said Java bytecode, which is not translated by said instruction translator, translates said received instruction to the specific instruction with use of a software virtual machine so as to be executed by said instruction execution block, and
wherein said instruction translator includes:
a first storage area for redefining classification of said Java bytecode into said first instruction group and said second instruction group;
a second storage area for redefining a relationship between an operation code of said Java bytecode and its processing content; and
a third storage area for redefining information used to dispose an array or field defined in said Java bytecode in a memory.

14. The information processing device according to claim 13,
wherein said information processing device writes a predetermined value in said first to third storage areas respectively, thereby coping with to the version upgrading of said software virtual machine.

15. The information processing device according to claim 14,
wherein said Java bytecode is classified into a plurality of instruction categories, and
wherein the first storage area stores the information according to each of the plurality of the instruction categories.
